(19) United States
(12) Patent Application Publication
(10) Pub. No.: US 2021/0058441 A1
(43) Pub. Date: Feb. 25, 2021

(54) METHODS AND DEVICES FOR MANAGING STREAMING CONTENT

(71) Applicant: Lenovo (Singapore) Pte. Ltd., New Tech Park (SG)

(72) Inventors: Arnold S. Weksler, Raleigh, NC (US); John Carl Mese, Cary, NC (US); Russell Speight VanBlon, Raleigh, NC (US); Nathan J. Peterson, Oxford, NC (US); Mark Patrick Delaney, Raleigh, NC (US)

(21) Appl. No.: 16/544,216

(22) Filed: Aug. 19, 2019

(51) Int. Cl. H04L 29/06; H04N 21/647; H04N 21/24

(52) U.S. Cl. CPC H04L 65/80; H04L 65/607; H04N 21/2402; H04L 65/601; H04N 21/647; H04L 65/608

(57) ABSTRACT

A computer implemented method, device, and computer program product for managing streaming content of a device are provided. The method is performed under control of one or more processors configured with specific executable program instructions. The method includes identifying one or more of characteristics of interest (COI) associated with a request to stream content from a content provider. The method applies a user defined quality of service (QoS) policy to the one or more COI. The user defined QoS policy correlates candidate data rates to the one or more COI. The method manages a COI-based data rate based on the one or more COI, the user defined QoS policy, and a data rate upper limit for the device. The method communicates the COI-based data rate to the content provider.

### BACKGROUND

Embodiments of the present disclosure generally relate to methods and devices for managing content streaming based on one or more user defined quality of service (QoS) policies.

Today, a wide variety of devices are offered for delivering streaming content to users, such as intelligent televisions, tablet devices, personal digital assistant devices, desktop and laptop computers, smartphones, smart watches, intelligent speakers, intelligent home theater systems, set-top boxes, digital media player consoles, gaming consoles, and the like. Content streaming devices vary in size, display technology, audio technology, and data rate capability. For example, available televisions and other video display devices have the capability of displaying video and audio content at various resolutions (e.g., 480p, 780p, HD, 4K, and the like). Further, a large portion of the video and audio content presented today on devices is conveyed from a content provider over a network in a streaming manner, such as video and music streaming services. Network connections have a finite bandwidth that is often shared between various devices at an end point, such as in a home or business. Content providers seek to stream the content at a data rate that meets a data rate upper limit of the device based on the capability of the device and devices are, by default, designed to negotiate content based on their data rate upper limit. Consequently, portions of bandwidth for a network may be wasted in connection with providing high quality content, even though a viewer may not appreciate the full quality/resolution of the content presented on the device.

With the increasing numbers and types of devices streaming content on a given network, the bandwidth of a given network may be insufficient to satisfy the data rate upper limit of every device streaming content on the network. Quality of service (QoS) controls implemented on network routers can, to an extent, be used to control and manage network resources. For example, QoS controls allow a user (e.g., administrator) of a network to adjust QoS settings (e.g., data traffic quality) on a network based on device-specific identifiers and physical addresses of devices associated with the network. However, conventional QoS controls do not allow for management of the finite bandwidth of the network within a set of user defined criteria, based on one or more of type of content, type of viewers, type of device, and the like, to ensure that streaming of low priority content does not adversely impact the quality of streaming of high priority content on the network.

Accordingly, a need remains for methods, devices, and computer program products that manage bandwidth usage for streaming content and that overcome the foregoing and other disadvantages of conventional approaches.

### SUMMARY

In accordance with embodiments herein, a computer implemented method for managing streaming content of a device is provided. The method is performed under control of one or more processors configured with specific executable program instructions. The method includes identifying one or more of characteristics of interest (COI) associated with a request to stream content from a content provider. The method applies a user defined quality of service (QoS) policy to the one or more COI. The user defined QoS policy correlates candidate data rates to the one or more COI. The method manages a COI-based data rate based on the one or more COI, the user defined QoS policy, and a data rate upper limit for the device. The method communicates the COI-based data rate to the content provider.

Optionally, the one or more COI may include one or more of types of content, genre of content, types of viewers, and types of devices associated with the request to stream content. The types of viewers may include a first type of viewer and a second type of viewer and the identifying one or more COI may include identifying the first type of viewer. The user defined QoS policy may include a first candidate data rate for the first type of viewer and a second candidate data rate for the second type of viewer that is less than the first data rate and the managing the COI-based data rate may include selecting the first candidate data rate. The types of viewers may include a first type of viewer and a second type of viewer and the identifying one or more COI may include identifying the second type of viewer. The user defined QoS policy may include a first candidate data rate for the first type of viewer and a second candidate data rate for the second type of viewer that is less than the first candidate data rate and the managing the COI-based data rate may include selecting the second candidate data rate.

Optionally, the types of content may include a first type of content and a second type of content and the identifying one or more COI may include identifying the first type of content. The user defined QoS policy may include a first candidate data rate for the first type of content and a second candidate data rate for the second type of content that is less than the first data rate and the managing the COI-based data rate may include selecting the first candidate data rate. The types of content may include a first type of content and a second type of content and the identifying one or more COI may include identifying the second type of content. The user defined QoS policy may include a first candidate data rate for the first type of content and a second candidate data rate for the second type of content that is less than the first candidate data rate and the managing the COI-based data rate may include selecting the second candidate data rate. The COI-based data rate may be less than the data rate upper limit for the device. The COI-based data rate may be a first COI-based data rate. The method may include streaming content at the device at the first COI-based data rate. The method may determine a network utilization associated with the network. The method may perform the applying and managing in further response to the network utilization exceeding a threshold. The managing may include selecting a second COI-based data rate that is less than the first COI-based data rate.

In accordance with embodiments herein, a device for managing streaming content is provided. The device includes one or more processors and memory storing program instructions accessible by the one or more processors. Responsive to execution of the program instructions, the one or more processors identify one or more characteristics of interest (COI) associated with a request to stream content from a content provider. The one or more processors may apply a user defined quality of service (QoS) policy to the one or more COI. The user defined QOS policy may correlate candidate data rates to the one or more COI. The one or more processors may manage a COI-based data rate based on the one or more COI, the user defined QOS policy, and a data rate upper limit for the device. The one or more processors may communicate the COI-based data rate to the content provider.

Optionally, the one or more COI may include one or more of types of content, genre of content, types of viewers, and types of devices associated with the request to stream content. The types of viewers may include a first type of viewer and a second type of viewer and the one or more processors, as part of the identify, may identify the first type of viewer. The user defined QoS policy may include a first candidate data rate for the first type of viewer and a second data rate for the second type of viewer that is less than the first data rate and the one or more processors, as part of the manage, may select the first data rate. The types of viewers may include a first type of viewer and a second type of viewer and the one or more processors, as part of the identify, may identify the second type of viewer. The user defined QoS policy includes a first candidate data rate for the first type of viewer and a second data rate for the second type of viewer that is less than the first data rate and the one or more processors, as part of the manage, may select the second data rate.

Optionally, the types of contents may include a first type of content and a second type of content and the one or more processors, as part of the identify, may identify the first type of content. The user defined QoS policy may include a first candidate data rate for the first type of content and a second data rate for the second type of content that is less than the first data rate and the one or more processors, as part of the manage, may select the first data rate. The types of contents may include a first type of content and a second type of content and the one or more processors, as part of the identify, may identify the second type of content. The user defined QoS policy includes a first candidate data rate for the first type of content and a second data rate for the second type of content that is less than the first data rate and the one or more processors, as part of the manage, may select the second data rate. The COI-based data rate may be less than the data rate upper limit for the device. The COI-based data rate may be a first COI-based data rate. The one or more processors may stream content at the device at the first COI-based data rate. The one or more processors may determine a network utilization associated with the network. The one or more processors may perform the applying and managing in further response to the network utilization exceeding a threshold.

In accordance with embodiments herein, a computer program product including a non-signal computer readable storage medium including computer executable code is provided. The computer program product identifies one or more characteristics of interest (COI) associated with a request to stream content from a content provider. The computer program product applies a user defined quality of service (QoS) policy to the one or more COI. The user defined QoS policy correlates candidate data rates to the one or more COI. The computer program product manages a COI-based data rate based on the one or more COI, the user defined QoS policy, and a data rate upper limit for the device. The computer program product communicates the COI-based data rate to the content provider.

Optionally, the computer program product may contain computer executable code to stream content at the device at the first COI-based data rate. The computer program may determine a network utilization associated with the network. The computer program product may perform the applying and managing in further response to the network utilization exceeding a threshold. The COI-based data rate may be less than the data rate upper limit for the device.

### DESCRIPTION OF THE DRAWINGS

FIG. 1 illustrates a system for managing content streaming implemented in accordance with embodiments herein.

FIG. 2 illustrates a functional diagram of portions of the system of FIG. 1 as well as a first example of certain data, information, and content conveyed in accordance with embodiments herein.

FIG. 3 illustrates a functional diagram of portions of the system of FIG. 1 as well as a second example of certain data, information, and content conveyed in accordance with embodiments herein.

FIG. 4A illustrates a process for managing content streaming in accordance with embodiments herein.

FIG. 4B illustrates an optional additional process to the process of FIG. 4A for managing content streaming in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

### Terms

The term “user defined QoS policy” refers to “user defined” as the QoS policy is not determined based on conventional QoS parameters implemented to manage data traffic on a network to reduce packet loss, latency, and jitter on a network. Instead, the “user defined” QoS polices are based on conditions and/or priorities assigned by a user to different types of content, genre of content, types of viewers (or consumers), types of devices, status of devices, and the like. A user defined QoS policy correlates candidate data rates to the one or more COI. Examples of user defined QoS policies include conditional statements defined by a user that prioritize types of the COI relative to one other and/or set a maximum and/or a minimum data rate for the types of the COI that the electronic device 120 will utilize to negotiate content with the content provider 112. In one example, a user defined QoS policy pertaining to a type of viewer includes “When my kids are watching TV, adjust the quality of the stream to a much lower setting (e.g., 780p) than the setting when I might be watching (e.g., 4K or the device resolution or data rate upper limit).” In another example, a user defined QoS policy pertaining to a genre of content includes “Based on cartoons being watched, adjust the quality of the stream to a lower setting than the device resolution upper limit (e.g., 480p vs. HD).” In another example, a user defined QoS policy pertaining to a genre of content includes “Based on watching the news, stream content at a lower quality than the device resolution upper limit (e.g., 780p vs. HD).” In another example, a QoS policy pertaining to a genre of content includes “Listen to classical music at the device data rate upper limit but listen to rock and roll music at a data rate less than the device data rate upper limit.” In another example, a QoS policy pertaining to a genre of content includes “Based on listening to an audio sports broadcast, stream content at a data rate less than the device data rate upper limit.” In yet another example, a QoS policy pertaining to a genre of content includes “Identify a commercial and stream content at a data rate less than the data rate assigned the primary content (e.g., 480p vs. HD). In another example, a user defined QoS policy pertaining to a type of content includes “Based on viewing pictures, stream content at the highest level possible (e.g., the device resolution or data rate upper limit).” In another example, a user defined QoS policy pertaining to the status of an electronic device 120 includes “Based on engagement of my surround sound, stream content at the highest level possible (e.g., the device resolution or data rate upper limit).”

The term “characteristic of interest-based data rate” or “COI-based data rate” refers to “COI-based” as the data rate is not based on the technical capabilities of the electronic device or any other hardware. Instead, the “COI-based” data rate is derived from one or more user defined QoS policies. The COI-based data rate may be determined in various manners, such as based on the type of content, genre of content, types of viewers, types of devices, status of devices, components being used, type of network connection and the like. Various factors may affect the COI-based data rate that is appropriate to stream content in a manner to achieve a particular resolution. By way of example, the COI-based data rate is based in part on the bit rate associated with the content. For example, content may be encoded at a low or a high bit rate, regardless of the resolution at which the content is to be output at an electronic device. Another factor that affects the COI-based data rate concerns the nature of the content server from which the content is streamed. The content server plays a role in the quality of the streaming content and quality will vary depending on a degree to which the content server is busy. Another factor that affects the COI-based data rate concerns the type of protocol being used for streaming. There are different protocols that may be used in connection with streaming content, where each protocol may have a different data rate associated therewith. By way of example only, the QoS manager may determine that a 10 Mbps data rate is appropriate to stream video content in a manner that is able to be displayed with a resolution of 1080 p.

The term “utilization information” refers to information characterizing a load experienced by a network. Utilization information may include the bandwidth capability of a network, network load experienced by the network, or a percent utilization of the bandwidth capability of a network. The utilization information of the network may be calculated based on trend data based on prior utilization of the network. The utilization information may include an ensemble of utilization information values that are mathematically combined, such as through averaging, obtaining a mean, median, etc., to form a composite current utilization information value (e.g., a moving average).

The term “obtain” or “obtaining”, as used in connection with data, signals, information and the like, includes at least one of i) accessing memory of a network hub or resource manager where the data, signals, information, etc. are stored, ii) receiving the data, signals, information, etc. over a wireless communications link between the electronic device and the network hub, and/or iii) receiving the data, signals, information, etc. at a resource manager over a network connection. The obtaining operation, when from the perspective of an electronic device, may include sensing new signals in real time, and/or accessing memory to read stored data, signals, information, etc. from memory within the electronic device. The obtaining operation, when from the perspective of a network hub, includes receiving the data, signals, information, etc. at a transceiver of the network hub where the data, signals, information, etc. are transmitted from an electronic device and/or a resource manager. The obtaining operation may be from the perspective of a resource manager, such as when receiving the data, signals, information, etc. at a network interface from a network hub and/or directly from an electronic device. The resource manager may also obtain the data, signals, information, etc. from local memory and/or from other memory, such as within a cloud storage environment and/or from the memory of a workstation.

### System Overview

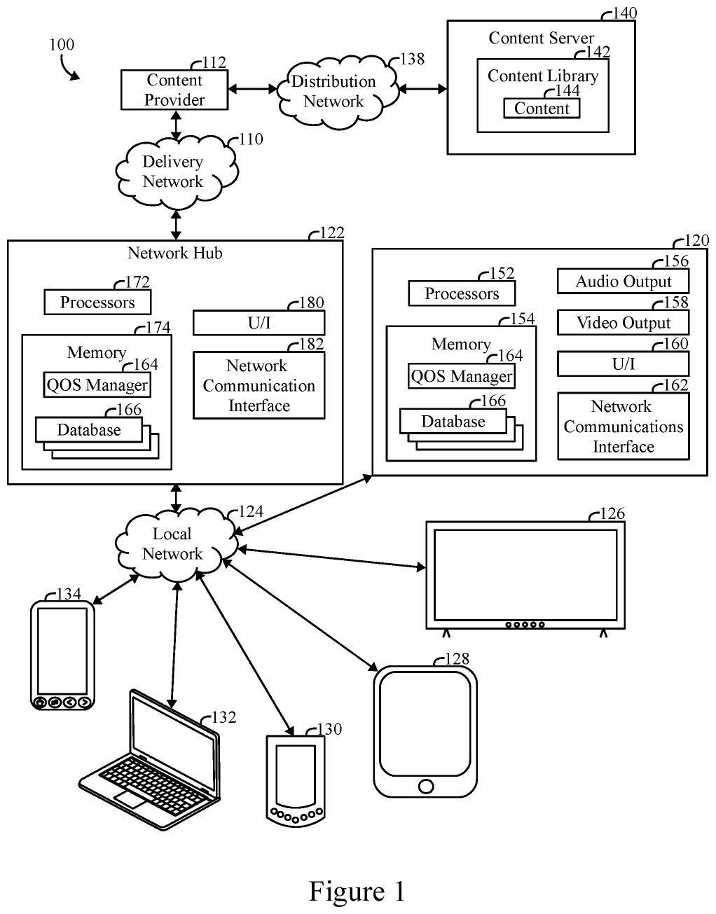

FIG. 1 illustrates a system 100 implemented in accordance with embodiments herein to manage audio and/or video content streaming. The system 100 includes a content provider 112 coupled to a content server 140 through a distribution network 138. The content provider 112 also communicates bidirectionally with one or more electronic devices 120, through a network hub 122 associated with a local network 124 (e.g., a home network), over a delivery network 110. A skilled artisan will appreciate that the delivery network 110 may connect a plurality of electronic devices 120, on the same local network 124 or different local networks, to the content provider 112. The distribution network 138 connects a content server 140, content library 142, and content 144 to the content provider 112. Based on receiving a request to stream content, the content provider 112 transmits a request for the content 144 to the content server 140. The content server 140 retrieves the content 144 from the content library 142 and returns the content 144 to the content provider 112. The content provider 112 transcodes the content 144 at the COI-based data rate. At 310, the content provider 112 transmits the content 144 to the electronic device 120, via the network 124, for streaming at the COI-based data rate. In one embodiment, the content server 140 is a general-purpose server computer that supplies the content 144 stored in the content library 142 to the content provider 112. A skilled artisan will appreciate that the distribution network 138 may connect a plurality of content servers 140 to the content provider 112. The content provider 112 may maintain separate user accounts in connection with the network hub 122 and/or the electronic device 120, or groups thereof, in order to provide audio and/or video content 144 in accordance with the corresponding user account information. Examples of content providers 112 include Netflix, Amazon Prime Video, HBO Now, Sling TV, Hulu Plus, Apple TV, Pandora Radio, Apple Music, Spotify, PlayStation Now, GeForce Now, Xbox Game Pass, Apple Podcast, Skype, WhatsApp, as well as television networks, cable providers, and the like.

For example and without limitation, the content provider 112 may provide an on-demand streaming service which allows users to select and watch/listen to video and/or audio content 144 when they choose to, rather than having to watch/listen at a specific broadcast time. The content provider 112 and electronic device 120 may, for example and without limitation, use Over-the-Top (OTT) or like technology to stream audio and/or video content 144 over the internet (via broadband or mobile data) on demand to electronic devices 120. The delivery network 110 and the distribution network 138 may represent public communication networks (e.g., the Internet) that connect the content provider 112 to the electronic device 120, via the network hub 122 associated with the local network 124, and the content server 140.

The network hub 122 is a controller or a router implemented on the network 124 (e.g., a home network) that communicates and routes traffic between public communication networks (e.g., delivery network 110) and electronic devices 120 connected to the local network 124. One example of a network hub 122 includes one or more processors 172, memory 174, a user interface 180, a network communications interface 182, and various other mechanical components, electrical circuits, hardware, and software to support operation of the network hub 122. The memory 174 also stores one or more application programs to implement a QoS manager 164, a database 166 correlating COI to COI-based data rates, as well as other software, information and data as described herein.

The one or more electronic devices 120 communicate bidirectionally with one or more content providers 112, over the delivery network 110, through the network hub 122 associated with the local network 124. Examples of electronic devices 120 include devices capable of delivering streaming content 144 to users, such as intelligent televisions 126, tablet devices 128, personal digital assistant devices 130, desktop and laptop computers 132, smartphones 134, smart watches, intelligent speakers, intelligent home theater systems, set-top boxes, digital media player consoles, gaming consoles, and the like. The electronic device 120 includes one or more processors 152, memory 154, an audio output 156 and/or a display output 158, a user interface 160, a network communications interface 162, and various other mechanical components, electrical circuits, hardware, and software to support operation of the electronic device 120. The memory 154 also stores one or more application programs to implement a QoS manager 164, a database 166 correlating COI to COI-based data rates, as well as other software, information and data as described herein. The electronic device 120 has a data rate upper limit based on the capability of the electronic device 120. For example, a video display device (e.g., intelligent televisions 126, tablet devices 128, laptop computers 132, smartphones 134, and the like) has a data rate upper limit corresponding to a resolution upper limit (e.g., 480p, 780p, HD, 4K, and the like) of the video display device. However, a video display device has the capability of displaying video content at various resolutions less than the resolution upper limit. Various device resolutions correspond to data rates for streaming content 144. The data rate represents the rate at which the content 144 is delivered to the electronic device 120.

The QoS manager 164 manages the streaming content of the one or more electronic devices 120. Utilizing the one or more processors (processors 152 and/or processors 172), the QoS manager 164 identifies one or more characteristic of interest (COI) associated with a request to stream content 144 from a content provider 112. Examples of COI include types of content, genre of content, types of viewers, types of devices, and status of devices associated with the request to stream content 144. Examples of types of content 144 include video, audio, pictures, games, messages, voice calls, any other type of streaming media, and, where applicable, the level of graphic intensity associated therewith. Further examples of types of content 144 include the ratings of content 144 based on content rating systems used to indicate the suitability of the content 144 for certain audiences (e.g., TV Parental Guidelines rating system, the Motion Picture Association of America film rating system, and the like). Examples of genre of content 144 include genre of video content (e.g., cartoons, news, commercials, movies, and the like), genre of audio content (e.g., classical music, country music, news, sports broadcasts, and the like), genre of games (e.g., action games, adventure games, simulation games, sports games, puzzle games, idle games, and the like). Examples of types of viewers include adults, children, guests, and the like. Types of children may be further subdivided based on age, age-based thresholds, or ranges of ages. Examples of types of devices include any type of electronic device 120 capable of delivering streaming content 144 to users. Examples of status of devices include other applications running on the device, the engagement of the device with peripheral devices (e.g., a surround sound system), indicia of whether the streaming content 144 is being actively viewed (e.g., the presence or absence of viewers in a region surrounding the device, engagement of the viewer with other electronic devices 120, and the like), utilization information indicating loads experienced by the device, and the like.

The QoS manager 164 applies a user defined QoS policy to the one or more COI. Optionally, the QoS manager 164 applies a plurality of user defined QoS policies to the one or more COI. The QoS manager 164 manages a COI-based data rate based on the one or more COI, the user defined QoS policy (or policies), and a data rate upper limit for the electronic device 120. The QoS manager 164 may store one or more files, tables, and/or databases associating various candidate data rates corresponding to the one or more COI.

In one example, the COI includes types of viewers. The types of viewers includes a first type of viewer (e.g., an adult) and a second type of viewer (e.g., a child). The user defined QoS policy includes a first candidate data rate (e.g., 4K) for the first type of viewer and a second candidate data rate (e.g., 480p) for the second type of viewer that is less than the first candidate data rate. When the QoS manager 164 identifies one or more COI including the first type of viewer, the QoS manger 164 manages the COI-based data rate by selecting the first candidate data rate. When the QoS manager 164 identifies one or more COI including the second type of viewer, the QoS manger 164 manages the COI-based data rate by selecting the second candidate data rate.

In another example, the COI includes types of content 144. The types of content 144 includes a first type of content (e.g., a voice call) and a second type of content (e.g., game). The user defined QoS policy includes a first candidate data rate (e.g., the device data rate upper limit) for the first type of content and a second candidate data rate (e.g., 780p) for the second type of content that is less than the first candidate data rate. When the QoS manager 164 identifies one or more COI including the first type of content, the QoS manger 164 manages the COI-based data rate by selecting the first candidate data rate. When the QoS manager 164 identifies one or more COI including the second type of content, the QoS manger 164 manages the COI-based data rate by selecting the second candidate data rate. The QoS manager 164 communicates the COI-based data rate to the content provider 112 and negotiates the data rate of the content 144 based on the COI-based data rate.

Optionally, the electronic device 120 streams the content 144 over the local network 124, determines utilization information associated with the local network 124 (e.g., a network utilization such as a network load, a percentage of bandwidth utilization, and the like), and performs the applying and managing operations in connection with the utilization information exceeding or falling below a threshold. For example, the COI-based data rate is a first COI-based data rate. The QoS manger 164 applies the previous and/or a different user defined QoS policy to the one or more COI and manages the first COI-based data rate based on the one or more COI, the previous and/or different user defined QoS policy, and the data rate upper limit of the electronic device 120. The QoS manager 164 manages the first COI-based data rate by selecting a second COI-based data rate that is, respectively, less than or greater than the first COI-based data rate. For example, the type of content 144 is a movie and the first COI-based data rate (e.g., HD) is less than the device resolution upper limit of the electronic device 120 (e.g., a 4K intelligent television). The QoS manager 164 periodically determines the network utilization associated with the local network 124. Based on the network utilization exceeding the threshold (e.g., exceeds 75% bandwidth utilization), the QoS manager 164 selects a second COI-based data rate (e.g., 780p) that is less than the first COI-based data rate, thereby throttling or reducing the data rate at which the movie is delivered to the electronic device 120 from the content provider 112. Additionally or alternatively, based on the network utilization falling below the threshold (e.g., falls below 75% bandwidth utilization), the QoS manager 164 selects a second COI-based data rate (e.g., 4K) that is greater than the first COI-based data rate, thereby increasing the data rate at which the movie is delivered to the electronic device 120 from the content provider 112.

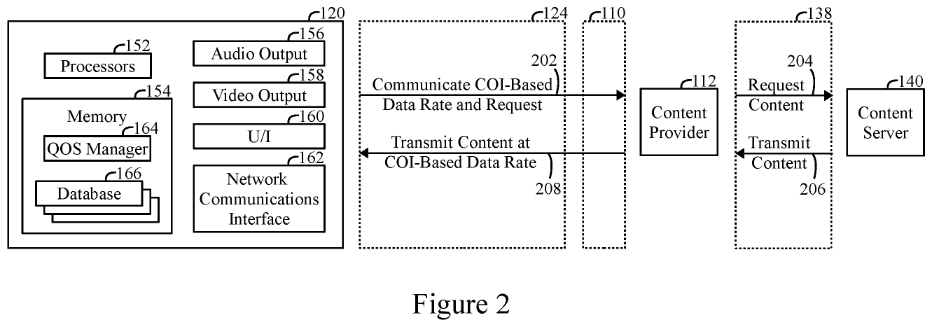

FIG. 2 illustrates a functional diagram of portions of the system of FIG. 1 as well as a first example of certain data, information, and content 144 conveyed in accordance with embodiments herein. In FIG. 2, the system 100 is implemented as described herein to run the QoS manager 164 on the electronic device 120. Responsive to a request to stream content 144 from a content provider 112, the QoS manger 164 utilizes the one or more processors 152 to identify one or more COI associated with the request. For example, the COI includes a first genre of content (e.g., an action movie) and a second genre of content (e.g., an animated movie). The QoS manager 164 identifies, as the COI, the first genre of content (e.g., the action movie) associated with the request. The QoS manager 164 applies the user defined QoS policy for the COI to determine a candidate data rate for the first genre of content based, at least in part, on the database 166 that correlates COI to COI-based data rates. For example, user defined QoS manager 164 related to a genre of content are “Based on watching an action movie, stream content at a first candidate data rate (e.g., 4K) that corresponds to the resolution upper limit of the electronic device” and “Based on watching an animated movie, stream content at a second candidate data rate (e.g., 480p) that corresponds to a resolution that is less than the resolution upper limit of the electronic device.” Based on the QoS manager 164 identifying one or more COI including the first genre of content and applying the user defined QoS policy, the QoS manger 164 manages the COI-based data rate by selecting the first candidate data rate (e.g., 4K). Based on the QoS manager 164 identifying one or more COI including the second genre of content and applying the user based QoS policy, the QoS manger 164 manages the COI-based data rate by selecting the second candidate data rate (e.g., 480p). At 202, the QoS manager 164 utilizes the one or more processors 152 to communicate the COI-based data rate to the content provider 112. The content provider 112 receives the request to stream content 144 and the COI-based data rate. At 204, based on the request, the content provider 112 transmits a request for the content 144 to the server 140. At 206, the content server 140 returns the content 144 to the content provider 112. The content provider 112 transcodes the content 144 at the COI-based data rate. At 208, the content provider 112 transmits the content 144 to the electronic device 120 for streaming at the COI-based data rate.

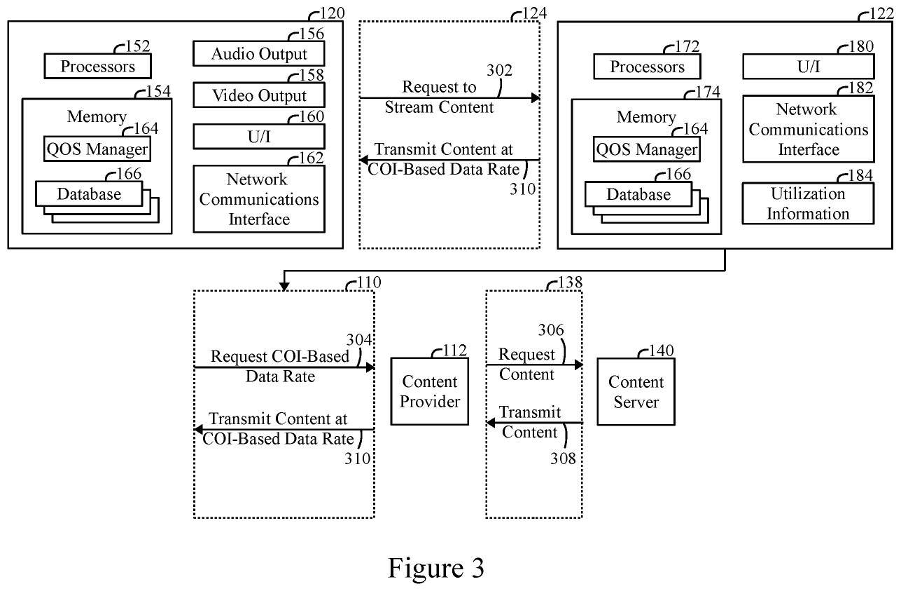

FIG. 3 illustrates a functional diagram of portions of the system of FIG. 1 as well as a first example of certain data, information, and content 144 conveyed in accordance with embodiments herein. In FIG. 3, the QoS manager 164 is implemented on the network hub 122 and manages the streaming content 144 of the one or more electronic devices 120 connected to the local network 124. At 302, the electronic device 120 transmits a request to stream content 144 from a content provider 112 to the network hub 122. Responsive to the request to stream content 144, the QoS manger 164 utilizes the one or more processors 172 to identify one or more COI associated with the request. For example, the COI includes a first status of a device (e.g., connected to a surround sound system) and a second status of a device (e.g., not connected to the surround sound system). The QoS manager 164 identifies, as the COI, the first status of the device (e.g., connected to the surround sound system) associated with the request. The QoS manager 164 applies the user defined QoS policy for the COI to determine a first candidate data rate for the first status of the device based, at least in part, on the database 166 that correlates one or more COI to candidate data rates. For example, user defined QoS manager 164 related to a status of a device are “Based on connection to the surround sound system, stream content at a first candidate data rate (e.g., 4K) that corresponds to the resolution upper limit of the electronic device” and “Based on no connection to the surround sound system, stream content at a second candidate data rate (e.g., HD) that corresponds to a resolution that is less than the resolution upper limit of the electronic device.” Based on the QoS manager 164 identifying one or more COI including the first status of the device and applying the user defined QoS policy, the QoS manger 164 manages the COI-based data rate by selecting the first candidate data rate (e.g., 4K). Based on the QoS manager 164 identifying one or more COI including the second status of the device and applying the user defined QoS policy, the QoS manger 164 manages the COI-based data rate by selecting the second candidate data rate (e.g., HD). At 304, the QoS manager 164 utilizes the one or more processors 172 to communicate the COI-based data rate to the content provider 112. The content provider 112 receives the request to stream content 144 and the COI-based data rate from the network hub 122. At 306, based on the request, the content provider 112 transmits a request for the content 144 to the content server 140. At 308, the content server 140 returns the content 144 to the content provider 112. The content provider 112 transcodes the content 144 at the COI-based data rate. At 310, the content provider 112 transmits the content 144 to the electronic device 120, via the network 124, for streaming at the COI-based data rate. The electronic device 120 streams the content 144 over the local network 124. Additionally or alternatively, the QoS manager 164 determines utilization information 184 associated with the local network 124 (e.g., a network utilization such as a network load, a percentage of bandwidth utilization, and the like), and performs the applying and managing operations in connection with the utilization information 184 exceeding or falling below a threshold. Based on a current COI-based data rate that is different than the previous COI-based data rate, operations 304-310 are repeated to deliver the content 144 at the current COI-based data rate.

In an additional or alternative embodiment, the QoS manager 164 may be implemented on both the network hub 122 and one or more of the electronic devices 120 connected to the local network.

### Process for Managing Streaming Content

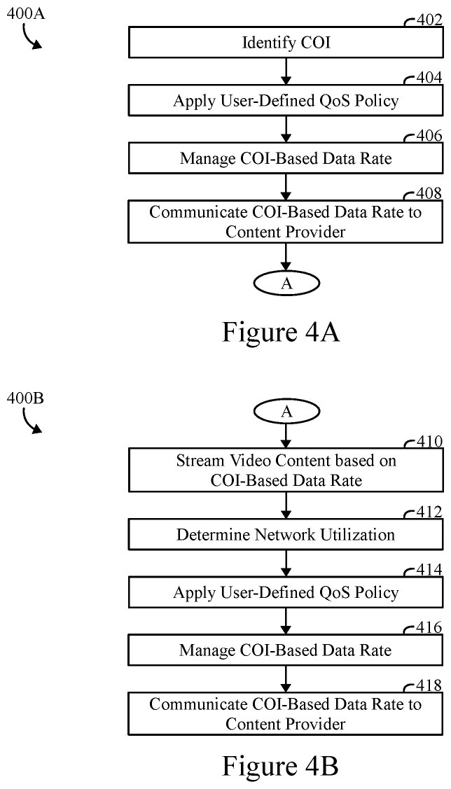

FIGS. 4A and 4B illustrate, respectively, a process 400A and optional additional process 400B for managing streaming content in accordance with embodiments herein. The processes 400A and 400B may be used to prioritize content 144 for quality reduction based on one or more characteristics of the device, the user, and/or the content and according to one or more user defined QoS policies. Additionally or alternatively, the processes 400A and 400B may be used to allocate local network 124 bandwidth based on one or more characteristics of the device, the user, and/or the content and according to one or more user defined QoS policies. The operations of FIGS. 4A and 4B may be implemented by processors (e.g., the processors 152 and 172), hardware and circuits within the systems described in the various embodiments herein. The operations of FIGS. 4A and 4B may be performed continuously or periodically. For simplicity purposes, the operations of FIGS. 4A and 4B, will be described in connection with one request, however it is recognized that an electronic device 120 and/or a network hub 122 may provide multiple requests in connection with managing streaming content 144 thereon. Optionally, the operations of FIGS. 4A and 4B may be performed upon select requests from one or more electronic devices 120 and/or a network hub 122, upon every request from one or more electronic devices 120 and/or a network hub 122, upon groups of requests from one or more electronic devices 120 and/or a network hub 122, or otherwise.

At 402, based on a request to stream content 144 received from an electronic device 120, the one or more processors (e.g., processors 152 and/or processors 172) identify one or more COI associated with the request. Examples of COI include types of content, genre of content, types of viewers, types of devices, and status of devices associated with the request to stream content 144. For example, the one or more COI includes a first genre of content (e.g., an adventure game) and a second genre of content (e.g., a puzzle game). The QoS manager 164 identifies, as the COI, the first genre of the content (e.g., an adventure game) associated with the request.

At 404, the one or more processors apply the user defined QoS policy to the one or more COI. The user defined QoS policy correlates candidate data rates to the one or more COI. For example, a user defined QoS policy includes “Based on an adventure game, stream content at the data rate upper limit for the device” and “Based on a puzzle game, stream content at a reduced data rate compared to the upper limit for the device.” The first candidate data rate, corresponding to the first genre of content (e.g., the action game), may correspond to the resolution upper limit for a 4K display device. The second candidate data rate, corresponding to the second genre of content (e.g., the puzzle game), may correspond to a reduced resolution for the 4K display device (e.g., 780p). Accordingly, in one example, the user defined QoS policy may prioritize certain genres of games (e.g., action games) to stream at higher data rates due to being more graphically intensive and de-prioritize other genres of games (e.g., puzzle games) to stream at lower data rates due to being less graphically intense compared to the upper limit of the device resolution.

At 406, the one or more processors manage the COI-based data rate based on the one or more COI, the user defined QoS policy, and the data rate upper limit associated with the electronic device 120. The one or more processors manage the COI-based data rate by selecting a candidate data rate as the COI-based data rate. For example, based on the genre of game being an action game, the one or more processors selects, as the COI-based data rate, a first candidate data rate from the database 166, the first candidate data rate corresponding to resolution upper limit of the electronic device 120 (e.g., a 4K display device). In another example, based on the genre of game being a puzzle game, the one or more processors selects, as the COI-based data rate, a second candidate data rate from the database 166 corresponding to resolution less than the resolution upper limit of the electronic device 120 (e.g., 480p for 4K display device).

At 408, the one or more processors communicate the COI-based data rate to the content provider 112. The content provider 112 receives the request to stream content 144 and the COI-based data rate from the network hub 122. Based on the request, the content provider 112 transmits a request for the content 144 to the content server 140 and the content server 140 returns the content 144 to the content provider 112. Based on the COI-based data rate imposed on the content provider 112, the content provider 112 transcodes and transmits the content 144 to the electronic device 120, via the network 124, for streaming at the COI-based data rate. Accordingly, based on a user defined QoS policy, higher priority content is delivered to the electronic device 120 for streaming at higher data rates and lower priority content is delivered to the electronic device 120 for streaming at lower data rates, thereby conserving network bandwidth.

Optionally, at 410, the process 400A continues with process 400B. At 410, the one or more processors stream the content 144 over the local network 124 at the COI-based data rate.

At 412, the one or more processors determine utilization information 184 associated with the local network 124 (e.g., a network utilization such as a network load, a percentage of bandwidth utilization, and the like).

At 414 and 416, the one or more processors perform the applying and managing operations in connection with the utilization information 184 exceeding or falling below a threshold. For example, based on the network utilization exceeding the threshold (e.g., exceeding 66% bandwidth utilization), the one or more processors select a second COI-based data rate (e.g., 780p) that is less than the first COI-based data rate (e.g., 4K). Additionally or alternatively, based on the network utilization falling below the threshold (e.g., falls below 75% bandwidth utilization), the one or more processors select a second COI-based data rate (e.g., 4K) that is greater than the first COI-based data rate (e.g., 780p).

At 418, the one or more processors communicate the second COI-based data rate to the content provider 112 to either throttling/reducing or increasing the data rate at which the action game is delivered to the electronic device 120 from the content provider 112

### CLOSING STATEMENTS

In accordance with at least one embodiment herein, to the extent that mobile devices are discussed herein, it should be understood that they can represent a very wide range of devices, applicable to a very wide range of settings. Thus, by way of illustrative and non-restrictive examples, such devices and/or settings can include mobile telephones, tablet computers, and other portable computers such as portable laptop computers.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general-purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying figures, it is to be understood that this description is not limiting and that various other changes and modifications may be affected therein by one skilled in the art without departing from the scope or spirit of the disclosure.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only and are thus not intended to limit in any way the definition and/or meaning of the term “controller.” The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming.

The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A and B” (where “A” and “B” represent claim elements), are used to encompass i) A, ii) B and/or iii) both A and B. For the avoidance of doubt, the claim limitation “associated with one or more of the client device and a user of the client device” means and shall encompass i) “associated with the client device”, ii) “associated with a user of the client device” and/or iii) “associated with both the client device and a user of the client device”. For the avoidance of doubt, the claim limitation “one or more of touch, proximity sensing, gesture or computer vision” means and shall encompass i) “touch”, ii) “proximity”, (iii) “sensing”, (iv) “gesture”, and/or (iv) “computer vision” and any sub-combination thereof.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method for managing streaming content of a device, the method comprising:
under control of one or more processors configured with specific executable program instructions:
identifying one or more characteristic of interest (COI) associated with a request to stream content from a content provider;
applying a user defined quality of service (QoS) policy to the one or more COI, the user defined QoS policy correlating candidate data rates to the one or more COI;
managing a COI-based data rate based on the one or more COI, the user defined QoS policy, and a data rate upper limit for the device; and
communicating the COI-based data rate to the content provider.

2. The method of claim 1, wherein the one or more COI include one or more of types of content, genre of content, types of viewers, and types of devices associated with the request to stream content.

3. The method of claim 2, wherein the types of viewers include a first type of viewer and a second type of viewer, the identifying one or more COI including identifying the first type of viewer, wherein the user defined QoS policy includes a first candidate data rate for the first type of viewer and a second candidate data rate for the second type of viewer that is less than the first candidate data rate, wherein managing the COI-based data rate includes selecting the first candidate data rate.

4. The method of claim 2, wherein the types of viewers include a first type of viewer and a second type of viewer, the identifying one or more COI including identifying the second type of viewer, wherein the user defined QoS policy includes a first candidate data rate for the first type of viewer and a second candidate data rate for the second type of viewer that is less than the first candidate data rate, wherein managing the COI-based data rate includes selecting the second candidate data rate.

5. The method of claim 2, wherein the types of content include a first type of content and a second type of content, the identifying one or more COI including identifying the first type of content, wherein the user defined QoS policy includes a first candidate data rate for the first type of content and a second candidate data rate for the second type of content that is less than the first candidate data rate, wherein managing the COI-based data rate includes selecting the first candidate data rate.

6. The method of claim 2, wherein the types of content include a first type of content and a second type of content, the identifying one or more COI including identifying the second type of content, wherein the user defined QoS policy includes a first candidate data rate for the first type of content and a second candidate data rate for the second type of content that is less than the first candidate data rate, wherein managing the COI-based data rate includes selecting the second candidate data rate.

7. The method of claim 1, wherein the COI-based data rate is less than the data rate upper limit for the device.

8. The method of claim 1, wherein the COI-based data rate is a first COI-based data rate; and further comprising:
streaming content at the device at the first COI-based data rate;
determining a network utilization associated with the network;
performing the applying and managing in further response to the network utilization exceeding a threshold.

9. The method of claim 9, wherein managing includes selecting a second COI-based data rate that is less than the first COI-based data rate.

10. A device for managing streaming content, the device comprising:
one or more processors;
memory storing program instructions accessible by the one or more processors, wherein, responsive to execution of the program instructions, the one or more processors:
identify one or more characteristic of interest (COI) associated with a request to stream content from a content provider;
apply a user defined quality of service (QoS) policy to the one or more COI, the user defined QOS policy correlating candidate data rates to the one or more COI;
manage a COI-based data rate based on the one or more COI, the user defined QOS policy, and a data rate upper limit for the device; and
communicate the COI-based data rate to the content provider.

11. The device of claim 10, wherein the one or more COI include one or more of each of: types of content, genre of content, types of viewers, and types of devices associated with the request to stream content.

12. The device of claim 11, wherein the types of viewers include a first type of viewer and a second type of viewer, wherein the one or more processors, as part of the identify, identify the first type of viewer, wherein the user defined QoS policy includes a first candidate data rate for the first type of viewer and a second candidate data rate for the second type of viewer that is less than the first candidate data rate, wherein the one or more processors, as part of the manage, select the first candidate data rate.

13. The device of claim 11, wherein the types of viewers include a first type of viewer and a second type of viewer, wherein the one or more processors, as part of the identify, identify the second type of viewer, wherein the user defined QoS policy includes a first candidate data rate for the first type of viewer and a second candidate data rate for the second type of viewer that is less than the first candidate data rate, wherein the one or more processors, as part of the manage, select the second candidate data rate.

14. The device of claim 11, wherein the types of content include a first type of content and a second type of content, wherein the one or more processors, as part of the identify, identify the first type of content, wherein the user defined QoS policy includes a first candidate data rate for the first type of content and a second candidate data rate for the second type of content that is less than the first candidate data rate, wherein the one or more processors, as part of the manage, select the first candidate data rate.

15. The device of claim 11, wherein the types of content include a first type of content and a second type of content, wherein the one or more processors, as part of the identify, identify the second type of content, wherein the user defined QoS policy includes a first candidate data rate for the first type of content and a second candidate data rate for the second type of content that is less than the first candidate data rate, wherein the one or more processors, as part of the manage, select the second candidate data rate.

16. The device of claim 10, wherein the COI-based data rate is less than the data rate upper limit for the device.

17. The device of claim 10, wherein the COI-based data rate is a first COI-based data rate; and wherein the one or more processors:
stream content at the device at the first COI-based data rate;
determine a network utilization associated with the network;
perform the applying and managing in further response to the network utilization exceeding a threshold.

18. A computer program product comprising a non-signal computer readable storage medium comprising computer executable code to:
identify one or more characteristic of interest (COI) associated with a request to stream content from a content provider;
apply a user defined quality of service (QoS) policy to the one or more COI, the user defined QoS policy correlating candidate data rates to the one or more COI;
manage a COI-based data rate based on the one or more COI, the user defined QoS policy, and a data rate upper limit for the device; and
communicate the COI-based data rate to the content provider.

19. The computer program product of claim 17, further comprising computer executable code to:
stream content at the device at the first COI-based data rate;
determine a network utilization associated with the network;
perform the applying and managing in further response to the network utilization exceeding a threshold.

20. The computer program product of claim 17, wherein the COI-based data rate is less than the data rate upper limit for the device.
